(19) United States
(12) Patent Application Publication
(10) Pub. No.: US 2019/0322013 A1
(43) Pub. Date: Oct. 24, 2019

(54) Tool and Apparatus for the Production of Foamed Insulation Boards

(71) Applicant: Kurtz GmbH, Kreuzwertheim (DE)

(72) Inventors: Jürgen Behringer, Külsheim (DE); Peter Lehmann, Faulbach (DE)

(21) Appl. No.: 16/382,566

(22) Filed: Apr. 12, 2019

(30) Foreign Application Priority Data
Apr. 18, 2018 (DE) 20 2018 102 138.9

(51) Int. Cl. B29C 44/58; B29C 33/30; B29C 44/44

(52) U.S. Cl. CPC B29C 44/585; B29C 44/445; B29C 33/303; B29C 33/308

(57) ABSTRACT

A tool is disclosed for the production of foamed insulation boards with two side faces lying opposite one another and all-round end faces such as facade insulation boards for insulating buildings. The tool has two mold halves, each having a mold frame and a mold base. The two mold halves together bound a mold cavity, which corresponds roughly to an insulation board to be produced, with the mold frames defining or bounding the end faces of the insulation board to be produced and the mold base defining or bounding the side faces. A setting device sets the position of the two mold halves in a plane parallel to the mold bases. The setting device is designed for stepless setting of the position of the two mold halves relative to one another.

### RELATED APPLICATIONS

This application claims priority to German Patent Application No. 20 2018 102 138.9, filed on Apr. 18, 2018, which is incorporated herein by reference in its entirety.

### BACKGROUND OF THE INVENTION

The present invention relates to a tool and an apparatus for the production of foamed insulation boards, in particular of facade insulation boards for the insulation of buildings.

Foamed facade insulation boards for the insulation of buildings are often made of foam particles, which are fed to a mold cavity bounded by a mold. The foam particles are welded or sintered in the mold cavity by means of a supply of steam.

Suitable tools and apparatus are known for example from DE 20 2004 003 679 U1, EP 2 610 043 A1 and EP 2 610 048 A1. Each of the tools used here has two mold halves, wherein at least one mold half is made up of a mold frame and a mold base. The mold base is made movable within the mold cavity, so that boards of varying thickness may be produced with one tool. If two mold halves are provided, then each of the two mold halves bounds a part of the mold cavity, together forming a plate-shaped cuboid hollow space. Preferably the mold halves with their hollow spaces are offset a little relative to one another, so that a step forms at the end faces of the insulation board to be produced. The step is also described as a stepped rabbet and provides that, in the insulation of a building, adjacent insulation boards with their respective stepped rabbets may be installed overlapping one another, so that there is no straight-line passage through the joints between two adjacent insulation boards. Consequently, with these stepped rabbets, a kind of labyrinth seal is formed between adjacent insulation boards. These rabbets are thus of considerable importance for the function of the insulation boards. Preferably, protruding stepped rabbets are formed on two adjacent end faces of an insulation board, and corresponding recessed stepped rabbets on the two other adjacent end faces. By this means it is possible to arrange any desired number of insulation boards flush with one another with overlapping stepped rabbets.

With the tools and apparatus described above, such insulation boards provided with stepped rabbets may be produced from foam particles.

The applicant has for internal purposes made tools in which the mold halves may be placed in different positions relative to one another, so that they may be fixed in their position by means of centering pins engaging in suitable holes in a series of holes. Here however only predetermined positions may be adopted, which are fixed by the spacing of the holes in the series of holes.

Depending on the thickness of the foamed boards and the plastic material used, stepped rabbets of different size would be advantageous.

DE 92 18 348 U1 discloses an apparatus for the production of particle foam parts, in which a first particle foam part is firstly produced in a mold. This particle foam part is then fixed in place by means of holding members. The walls of the tool are moved apart, so that a hollow space is created around the first particle foam part. The holding members hold the particle foam part roughly in the center of the hollow space. For this purpose the holding members have pins which are pressed into the particle foam part. Also provided are positioning punches which fit closely to the outer surface of the particle foam part, in order to position the particle foam part in the mold cavity. When the particle foam part is correctly positioned, then the positioning punches are removed and the particle foam part is held solely by means of the pins. Further foam particles are fed into the hollow space surrounding the particle foam part, and are made of a different material to the foam particles of the first particle foam part. These foam particles are welded under a supply of steam, and combine with the first particle foam part, which forms the core of a final product. This apparatus thus permits the production of foam particles with an inner core, which is made from a first plastic material, and an outer sheath made form a second plastic material.

Known from DE 198 08 421 C1 is a mold for the production of cuboid blocks of variable width made of foamable polystyrol. One side wall of this mold is movable, so that cuboid blocks of varying width may be produced.

Described in DE 21 52 248 C is a block mold for the production from formable polystyrol of blocks with variable cross-section. The mold is designed for the production of circular-cylindrical blocks. One of the end walls of the mold is movable, so that circular-cylindrical blocks of different height may be produced.

CH 668033 AS discloses an apparatus for the production of a molded body from at least two polystyrol foams of different density. The apparatus has a molding box in which, to begin with, a first molded section can be formed. Mold walls of the molding box are then moved back so that there is space for a second mold section.

### SUMMARY OF THE INVENTION

The invention is therefore based on the problem of creating a tool, an apparatus and a method for the production of foamed insulation boards, in particular facade insulation boards for the insulation of buildings, in which the facade insulation boards may be made with stepped rabbets of varying size.

The problem is solved by the subjects of the independent claims. Advantageous developments of the invention are set out in the relevant dependent claims. A tool for the production of foamed insulation boards, in particular of facade insulation boards for the insulation of buildings, wherein the insulation boards have two side faces lying opposite one another and all-round end faces, has two mold halves, each having a mold frame and a mold base. The two mold halves together define or bound a mold cavity, which corresponds roughly to an insulation board to be produced. The mold frames define or bound the end faces of an insulation board to be produced and the mold base defines or bounds the side faces. A setting device is provided for setting the position of the two mold halves in a plane parallel to the mold bases.

By this means, facade insulation boards for the insulation of buildings may be produced with stepped rabbets. In this way, facade insulation boards may be produced according to requirements, for example in terms of thickness, the relevant material and the modified stepped rabbet.

The mold cavity of the tool corresponds “roughly” to an insulation board to be produced since the insulation board, after welding of the foam particles in the mold cavity, contracts slightly, and therefore differs somewhat from the shape of the mold cavity.

This setting device can be embodied for stepless (e.g. continuously adjustable or smooth, as opposed to adjustable in certain intervals or steps) setting of the position of the two mold halves relative to one another.

Usually the mold frames have the shape of a rectangle. The setting device may be designed for setting the position of the two mold halves in a direction inclined to the edge of the rectangle. This direction is described below as the adjusting direction or the diagonal direction. The direction inclined can be inclined through 45° or through another angle, particularly in the range of 20° to 70° to an edge of the rectangle.

The setting of the position of the two mold halves in the diagonal direction is expedient when only one mold half is moved and the other mold half remains stationary in this respect. It may however also be expedient for both mold halves to be moved in a plane parallel to the mold bases, wherein the movement direction of the two mold halves is preferably aligned with two directions orthogonal to one another. In particular, the movement directions are aligned perpendicular or parallel to an edge of the rectangle of the mold frame. With two movement directions orthogonal to one another, stepped rabbets of varying size may be set at the end faces of the insulation board.

By adjusting in the diagonal direction, insulation boards are formed which have two protruding stepped rabbets and two adjacent end faces and two returning stepped rabbets on the other two end faces.

Each of the mold halves preferably has a press frame which may be connected to a press. Arranged on one of the two press frames is an adjusting frame, to which one of the mold frames and one of the mold bases are fixed. The adjusting frame is mounted movably on the press frame, and an actuator is provided for stepless movement of the adjusting frame relative to the press frame.

The press frame is a very rigid frame, which is able to transmit the forces of the press distributed over the entire extent of the tool. The adjusting frame may be frame-shaped or also in the form of a kind of framework structure hick holds the mold frame and the mold base.

The actuator may have an electrical, hydraulic or pneumatic drive unit. Such a drive unit makes it possible to adjust the offset of the two mold halves by means of a control unit. The offset may for example be remote-controlled, or set automatically on the basis of a specific processing program.

In principle, however, it is also possible to provide an actuator which may be operated manually.

A drive unit is preferably coupled to the actuator by means of a gear, and not by a chain. A chain has the drawback of needing regular oiling, which may lead to contamination.

Provided on the press frame are preferably several claws for fixing the adjusting frame. The claws may be operable hydraulically, pneumatically or electrically and act preferably on the periphery of the adjusting frame. For this purpose, the adjusting frame may have edges extending parallel to the adjusting direction, so that engagement by stationary claws is ensured irrespective of the actual position of the adjusting frame.

A slide bearing may be provided between the adjusting frame and the corresponding press frame.

The slide bearing serves in particular to support two contact faces of the adjusting frame and the press frame, which are arranged roughly parallel to the mold bases. The slide bearing may be formed by a slide plate and/or a ball bearing. In particular a smooth hard plate, for example, of VA steel, may be provided on the press frame or the adjusting frame, and a ball stud with a ball rolling on the smooth plate on the corresponding other frame.

In an apparatus for the production of foamed insulation boards, the tools are often arranged vertically. It may therefore be expedient to provide on the press frame at least one load bearing which, with vertical arrangement, fits closely on a lower end face of the adjusting frame, wherein the adjusting frame has adjacent to the load bearing a trough-shaped recess open at the bottom, so that the load bearing in a zero position abuts an apex of this recess. In this way the adjusting frame is positioned and held clearly relative to the press frame by force of gravity alone, when it is not so pressure-loaded by the actuator that it adopts another position.

Preferably, two load bearings are provided on the press frame.

At least one of the two mold halves may be provided with a depth setting device, by which the mold base may be moved relative to the corresponding mold frame in a direction roughly perpendicular to the plane of the mold base. By this means, the depth of the relevant mold half may be varied.

Preferably, the depth setting device has a drive unit, which may be driven by a control unit.

If both the depth setting device and also the setting device for setting the position of the two mold halves are provided with a drive unit, and each is capable of being driven by a control unit, then the molding tool may be set automatically by the control unit for the production of insulation boards of varying thickness. This is especially advantageous when both mold halves have such a depth setting device. The insulation boards which may be produced by this process may then be made with any desired thickness above or below the respective stepped rabbet and with stepped rabbets of any desired size.

The depth setting devices are preferably also designed such that they are able to set the mold bases steplessly relative to the mold frame and thus also set the depth of the respective mold halves steplessly.

With such a tool, the insulation boards may be customized in terms of their thickness and stepped rabbet, with the relevant parameters (thickness above and below the stepped rabbet and size of the stepped rabbet) specified by the customer requiring only transmission to the control unit, which then automatically sets the tool accordingly.

An apparatus for the production of foamed insulation boards has a tool, described above, and a press with which the two mold halves may be pressed together. In the compressed state they form the mold cavity in which the insulation board to be produced is formed by the feeding of foam particles and the fusing of these foam particles.

This apparatus preferably has a heating device for heating the mold cavity, so that the foam particles in the mold cavity may be welded together. The heating device may be a steam generator for the generation of steam. The heating device may also be a generator for the generation of electromagnetic waves. In principle, though, microwaves may also be used. However, this is not advantageous owing to their short wavelength, since it is difficult to obtain homogenous and even heating of the foam particles within the mold cavity using microwaves.

In the case of a generator for the generation of electromagnetic waves, the molding tool is made of a material which is substantially transparent to electromagnetic waves. Metal plates and metal frames may be unsuitable for this purpose, since they can inhibit the entry of electromagnetic waves into the mold cavity. However, the mold bases may be used as capacitor plates for application of the electromagnetic waves. Electrically conductive mold bases of metal may then be provided but need to be electrically insulated from the rest of the apparatus. Preferably, they are made with a coating that is transparent or semi-transparent to electromagnetic waves on the inner surface of the mold cavity. Such a semi-transparent coating has preferably similar dielectric loss properties to the foam particles to be welded, so that the inner boundary surface of the molding tool is heated in a similar manner to the foam particles. If on the other hand a steam generator is provided, then steam feed inlets are to be provided on the mold halves, in particular the mold bases. The steam feed inlets are steam nozzles. The steam nozzles may be connected separately to steam lines. It is however also possible to provide a steam chamber on the mold halves, on the outside relative to the mold cavity, which supplies all steam feed inlets with steam.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a front perspective view of a press frame and an adjusting frame of a mold half of a tool with a mold frame and a mold base;

FIG. 2 is a front perspective view of a press frame and an adjusting frame of a mold half of a tool without the mold frame and the mold base;

FIG. 3 is a rear perspective view of the mold half of FIGS. 1 and 2;

FIG. 4 is a rear perspective view of a mold half of a tool complementary to the mold half of FIGS. 1 to 3;

FIG. 5 is a front perspective view of the mold half of FIG. 4; and

FIG. 6 is a perspective view of the adjusting frame of FIGS. 1 to 3.

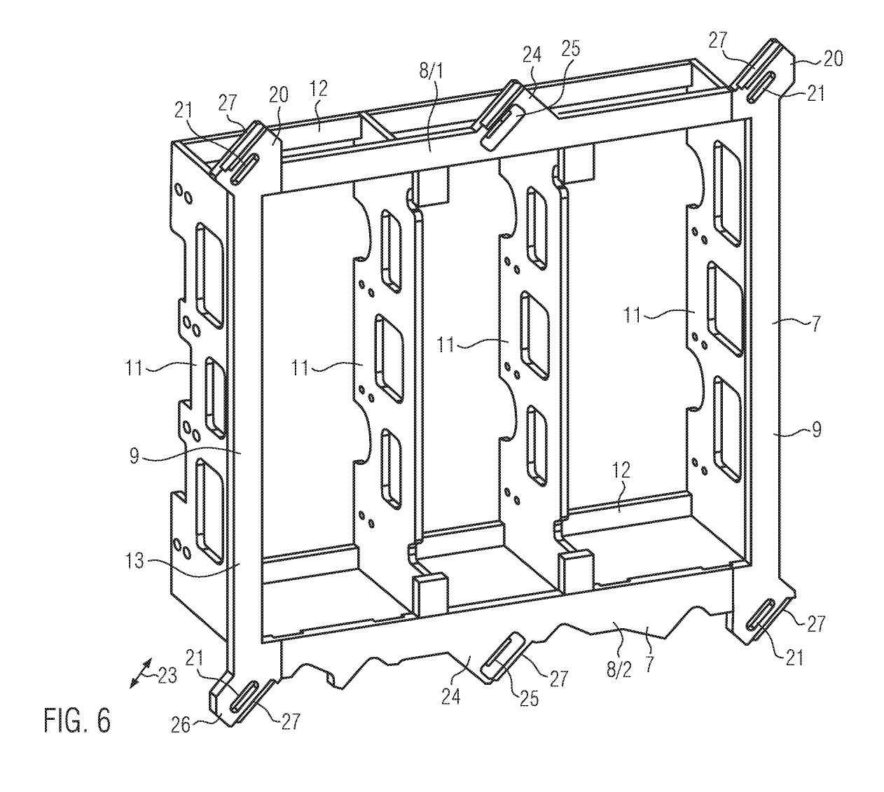

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention is explained below with the aid of an embodiment of a tool for the production of foamed insulation boards, in particular facade insulation boards for the insulation of buildings, which are welded into insulation boards from foam particles by heating with steam.

Such a tool has two mold halves 1, each including a mold frame 2 and a mold base 3. With the mold frame 2 and the mold base 3, each mold half 1 bounds a plate-shaped or cuboid hollow space. In operation, the two mold halves 1 are placed together by their open sides so that the two hollow spaces form a mold cavity which is closed on all sides and bounds a hollow space corresponding roughly to an insulation board to be produced.

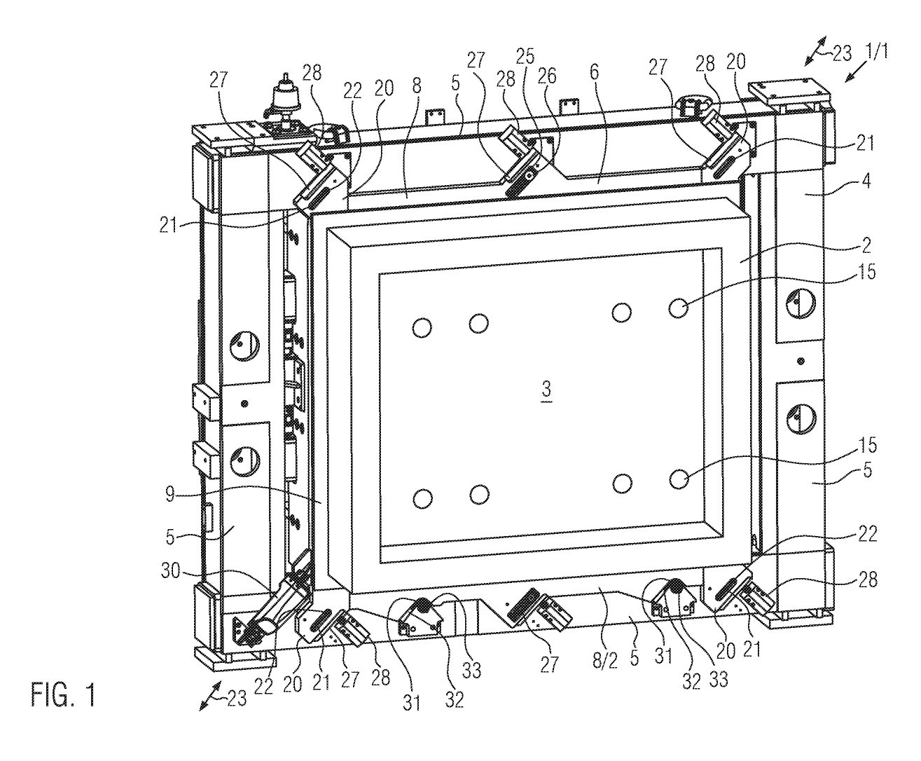

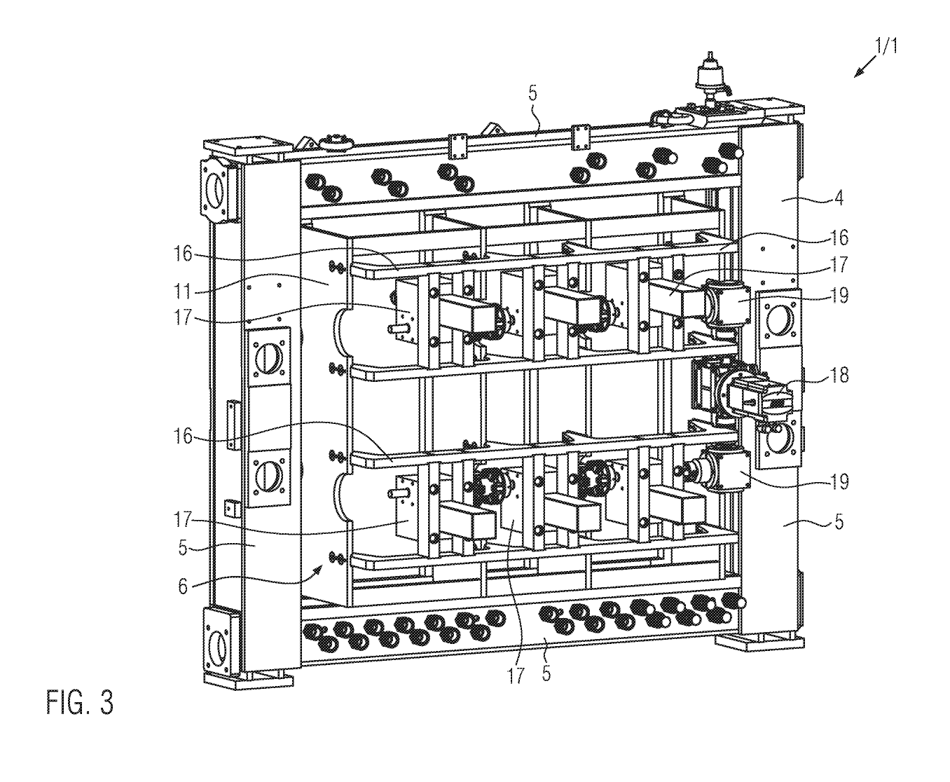

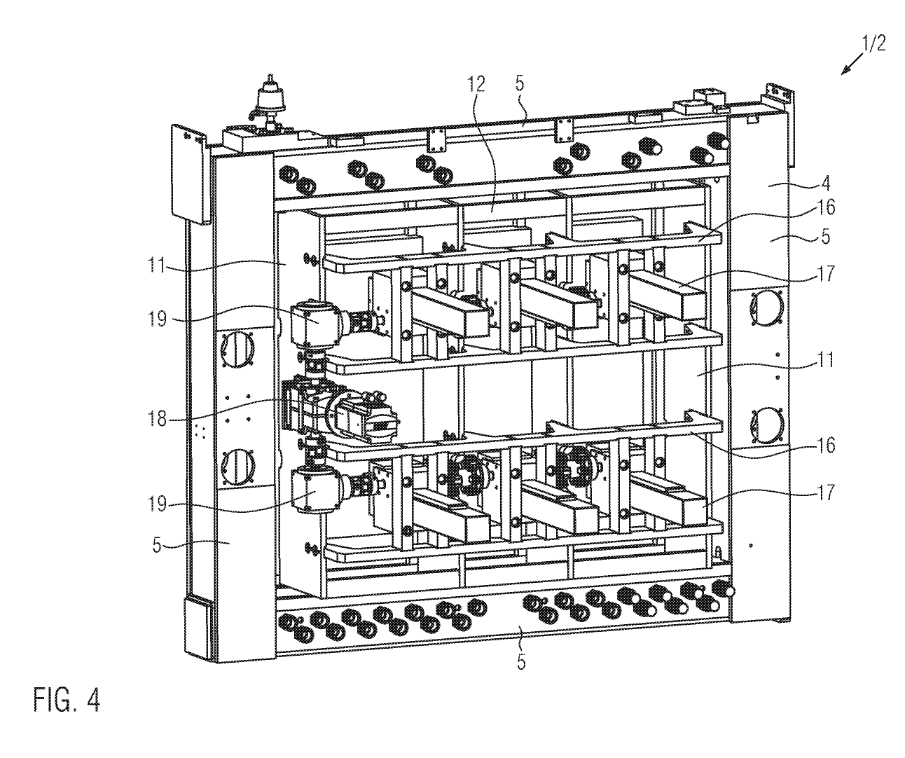

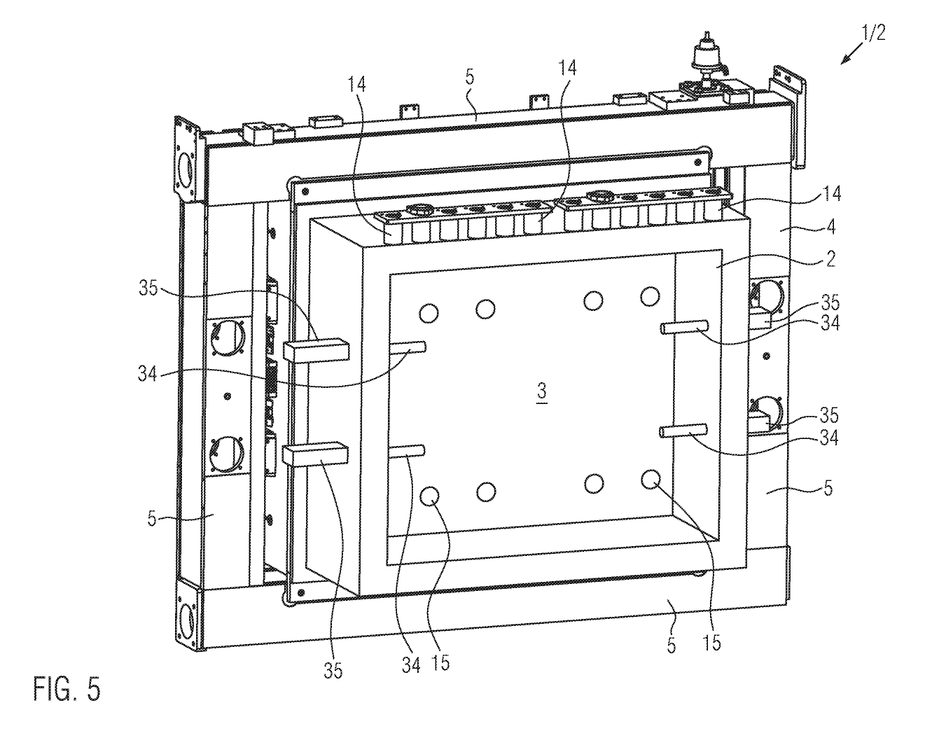

In operation, the mold halves 1 are arranged in a press (not shown) with which the mold halves 1 may be pressed together to form the mold cavity, or moved apart to demold a particle foam part which has been produced. One of the two mold halves 1/1 (FIGS. 1-3) is held stationary in the press, and the other mold half 1/2 (FIGS. 4, 5) is movable in the press. The side of the press which is not movable is described as the fixed side and the movable side as the moving side.

Below, with regard to each mold half 1, the side of the respective mold half facing the mold cavity is described as the “front”, and the side of the respective mold half facing away from the mold cavity is described as the “rear”.

Each of the mold halves 1 has a press frame 4, which may be connected to the press. The press frame is a rectangular frame made up of four frame parts 5. Each frame part 5 forms a tube with square cross-section and is made of thick steel, so that the press frame 4 can distribute the forces of a press evenly over the periphery of the respective mold half 1.

An adjusting frame 6 is mounted on the press frame 4 of at least one of the two mold halves 1. In the present embodiment, the mold half 1/1 fitted immovably in the press is provided with the adjusting frame 6. The adjusting frame 6 may be frame-shaped and hold one of the mold frames 2 and one of the mold bases 3. In the present embodiment, the adjusting frame 6 has an all-round frame element 7 with two longitudinal members 8 and two shorter cross-members 9. The longitudinal members 8 and the cross-members 9 are each made from a strip-shaped steel strip. Extending between the longitudinal members 8 are intermediate members 10, which run parallel to the cross-members 9 and, like the former, are made of strip-shaped steel strip. Provided at each of the cross-members 9 and intermediate members 10 are upright support plates 11. The support plates 11 are arranged at the rear of the cross-members 9 and intermediate members 10, standing perpendicular to the members 9, 10. Provided at the edges of the support plates 11 furthest away from the cross-members and intermediate members 9, 10 are strip-shaped reinforcing struts 12, which run parallel to the longitudinal members 8. The cross-members 9, intermediate members 10, support plates 11 and reinforcing struts 12 are welded, and thus form a single-piece basic structure of the adjusting frame 6.

The strip-shaped longitudinal members 8, cross-members 9 and intermediate members 10 are arranged in a common plane, with their fronts facing towards the respective mold base 3 of the mold halves 1. The frame element 7 formed by the longitudinal members 8 and cross-members 9 is therefore plate-shaped, and rectangular viewed from above.

Several longitudinal struts 16 are fixed at the rear to the support plates 11 and extend in the area between the cross-members 9 and parallel to the longitudinal members 8. Fixed to these longitudinal struts 16 are several lifting punches 17 which form a lifting mechanism for moving the respective lifting punch in a direction perpendicular to the respective mold base 3. The forward-facing ends of the lifting punches 17 are each attached to the mold base 3 of the mold half 1. A drive motor 18 is connected to the lifting punches 17 by means of two gears 19, so that the lifting punches 17 may be moved in or out synchronously.

In the present embodiment, two gears 19 are provided on each of the mold halves 1.

Depending on the size of the mold half and the arrangement of the lifting punches 17, it is also possible to provide just a single gear, or else several gears. The individual lifting punches 17 have a spindle drive, by which the rotary movement of the drive motor 18 is converted into a linear movement of the respective lifting punch 17. The spindle drive preferably has a ball screw for rapid adjustment of the respective base 3.

The lifting punches 17, together with the drive motor 18 and the gears 19, form a depth setting device of the respective mold half 1, by which the position of the respective mold base 3 relative to the respective mold frame 2, and thus the depth of the hollow space bounded by the mold half 1, may be set.

The depth setting devices may also be provided in each case with two or more drive motors, which drive the lifting punches or groups of lifting punches independently of one another, so that each mold base 3 may be tilted slightly in the mold frame 2.

The mold bases 3 are sealed from the mold frames by a continuous inflatable seal. To move the mold bases, the seal is emptied by vacuum, so that the respective mold base 3 is freely movable. The depth setting device is preferably designed so that the mold bases may be moved forward out of the mold frames 2, so that the continuous seals may be simply replaced.

Located on the mold frame 2 of the stationary mold half 1/2 are filler connections 14. Connected to these filler connections 14 are lines (not shown) for feeding and supplying the mold cavity with foam particles (FIG. 5). The filler connections 14 are arranged on the mold frame 2 as far forward as possible, so that they are not covered by the respective mold base 3, when the latter is in a forward position in the mold frame 2.

Additional filler connections 15 are provided on the mold bases 3 of the two mold halves 1 (FIGS. 1 and 5).

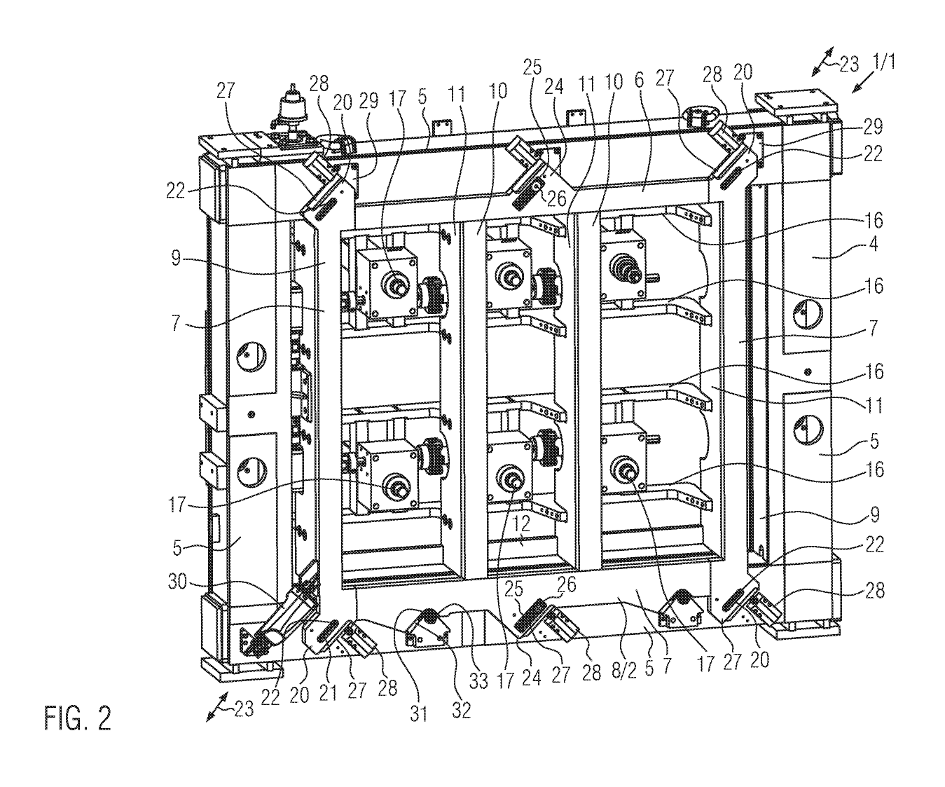

At each of the corner zones of the adjusting frame 6, the frame element 7 has an outwards extending projection 20, in which is formed a guide element 21 in the form of an elongated hole (FIGS. 1 and 2). All of these guide elements 21 are inclined in the same direction by 45° relative to the axial direction of the longitudinal members 8 and cross-members 9 respectively. The guide elements 21 are therefore all aligned parallel to one another. This direction is described below as the diagonal direction 23, even if the term “diagonal” is mathematically incorrect for such a non-square rectangle for a direction inclined by 45° relative to a longitudinal edge. Guide pins 22, which are fixed to the press frame 4, engage in each of the guide elements 21, so that the adjusting frame 6 may be moved a short distance to and fro in the diagonal direction 23 relative to the press frame 4.

Provided at the longitudinal centers of the longitudinal members 8 are outwards protruding projections 24, on which are formed elongated holes running in the diagonal direction 23 and forming securing holes 25. Through each of the securing holes there extends a securing pin 26, which is fixed to the press frame 4 and has a head extending over the corresponding securing hole 25, so that the adjusting frame 6 is held with play on the press frame 4, from which it cannot be removed without loosening the securing pin 26.

Formed on all projections 20, 24 is an edge 27 extending in the diagonal direction 23. Adjacent to each edge 27 is a hydraulic claw 28 which is attached to the press frame 4. Each claw 28 has a gripper which may be moved in and out hydraulically so that, in the extended state, it rests on the projections in the area of the edges 27 and presses the adjusting frame 6 against the press frame 4, fixing it in the respective relative position with respect to the press frame 4.

In the area of the projections 20, at the corners of the adjusting frame 6, a slide plate 29 with a smooth surface is provided in each case on the press frame 4. The adjusting frame 6 has on the projections 20 in each case a ball stud (not shown) which rolls on the slide plate 29 so that, with the claws 28 loosened, the adjusting frame 6 may be moved with minimal friction in the diagonal direction 23 relative to the press frame 4.

For moving the adjusting frame 6 relative to the press frame 4, an actuator 30 is fixed to the press frame 4 and acts on the adjusting frame 6, exercising a linear movement. The actuator 30 is aligned in the diagonal direction 23. It has a drive motor (not shown) which is connected to the control unit. The control unit can thus control a movement of the adjusting frame 6 relative to the press frame 4 in the diagonal direction 23.

The mold half, according to the present embodiment, is designed for vertical operation, i.e. the press frame 4 and the adjusting frame 6 stand vertically. The adjusting frame 6 therefore has an upper longitudinal member 8/1 and a lower longitudinal member 8/2. Formed on the lower longitudinal member 8/2 are two trough-shaped recesses 31, open at the bottom. The trough-shaped recesses 31 merge on one side into a boundary edge 32 running in the diagonal direction 23. A load roller 33 is fixed to the press frame 4 in the area of each of the trough-shaped recesses 31. In a position with the adjusting frame 6 lowered to its maximum extent, the load roller 33 makes contact with the apex of the trough-shaped recess 31. This position of maximum lowering is also described as the zero position. If the adjusting frame 6 is moved from this zero position by means of the actuator 30, then the adjusting frame 6 slides with its boundary edges 32 along the respective load rollers 33. The load rollers 33 thus form a load bearing for the adjusting frame 6. With the actuator 30 unactuated, the load rollers 33 bear substantially the whole weight of the adjusting frame 6 and the components fastened to it.

Provided on the mold frame 2 of the stationary mold half 1/2 are locating pins 34 which protrude radially inwards on the mold frame 2. The locating pins 34 may he retracted by means of, in each case, one linear actuator 35, so that the locating pins end with their free radially-inwards end flush with the surface of the mold frame 2. The locating pins are arranged on the front edge of the mold frame 2 and are in a vertical row beneath the tiller connections 14. The linear actuator may be in the form of a pneumatic cylinder.

The production of an insulation board using the tool described above is explained below.

The mold halves I are first of all in the moved-apart state. The adjusting frame 6 is moved by means of the actuator 30 into the predetermined position. The predetermined position of the adjusting frame is generally such that the mold frame 2 of the movable mold half 1/1 is somewhat offset relative to the mold frame 2 of the stationary mold half 1/2, in order to produce an insulation board with stepped rabbet.

When the adjusting frame 6 is in the desired position, then it is fixed to the press frame 4 by means of the claws 28.

The locating pins 34 are in the moved-out position (FIG. 5).

The two mold halves are then pressed together by the press, so that the two mold halves together form the mold cavity.

Using the depth setting device, the mold bases 3 are so adjusted relative to the mold frame 2 that the mold halves have a desired depth.

Via the filler connections 14, 15, foam particles are fed to the mold cavity. The mold cavity is completely filled with foam particles.

The foam particles are heated in an essentially known manner, so as to fuse with one another. The fusing of the foam particles is also described as welding or sintering. The heating of the foam particles is usually effected by a supply of steam. For this purpose, suitable steam nozzles (not shown) are provided in the mold bases 3 and/or in the mold frame 2.

The foam particles may also be heated by electromagnetic waves, in particular radio waves or microwaves. Radio waves are preferred in this connection since microwaves, owing to their short wavelength, often produce uneven heating, which is disadvantageous especially in the production of large insulation boards. It is also possible to heat the foam particles by a combined supply of steam and electromagnetic waves.

The foam particles are welded sufficiently for them to adhere to one another but not be completely welded.

Next, at least one and preferably both mold bases are moved back a short distance, so that a hollow space forms between the foam particles in the mold cavity and the mold bases 3. The already existing particle foam part is held immovably in the mold cavity by means of the locating pins 34.

This hollow space is filled with foam particles. The foam particles are fed into the mold bases 3 solely through the filler connections 15, since the filler connections 14 are blocked by the already existing particle foam part.

When the hollow spaces between the existing particle foam part and the mold bases 3 are completely filled with further foam particles, then the locating pins 34 are fully retracted by the linear actuators 35, so that they no longer extend into the mold cavity.

The foam particles and the existing particle foam part are welded and joined together by the provision of heat (from hot steam or electromagnetic radiation of a combination of both). Here the foam particles expand in such a way that the holes left by the retracted locating pins 34 are also completely closed.

The particle foam part produced in this way is cooled. The cooling may be passive, in that no further heat is provided. It is however also possible to cool the tool passively by, for example, allowing cooling air to flow over the outer surfaces of the tool. Due to cooling, the particle foam part, which is an insulation board, is cured.

The two mold halves 1 are moved apart by the press, to demold the insulation board.

With this process it is therefore possible to produce an insulation board with several layers, wherein the individual layers may be made of different plastic material. The middle layer is preferably optimized in respect of insulation properties. The one or two outer layers are preferably optimized in respect of further processing. The insulation boards are attached to buildings and plastered. The outer layer preferably has a texture to which plaster adheres well. If both sides of the insulation board are provided with such a layer, then blends may be used, so that it is easier to use such blends correctly.

Since the adjusting frame 6 may be moved steplessly, the stepped rabbet may accordingly be set freely and steplessly. Since both mold halves have an adjustable mold base 3, the respective thickness from the stepped rabbet to the two side faces may be set individually.

It is therefore possible to produce insulation boards with a stepped rabbet and thickness, in particular thickness sections, which may be freely set from the stepped rabbet to the side faces.

This tool may also be used to produce insulation boards with no stepped rabbet. Such insulation boards may be produced on the one hand by providing that the adjusting frame 6 is so adjusted that the two mold frames 2 of the two mold halves 1 are not offset relative to one another. This means that, at the impact faces of the two mold frames 2, a burr is formed on the finished particle foam part.

This burr may be avoided if one of the mold bases 3 is moved forward so far that a portion of it protrudes at its mold frame 2. These mold bases 3 then form a punch which extends into the mold frame 2 of the other mold half 1. Because of this, the mold cavity is bounded solely by a single one of the two mold frames 2 and the two mold bases 3, so that no continuous burr forms on the particle foam part.

The movable mold half 1/2 is therefore made with a maximum depth of 400 millimeters (mm). This means that the insulation boards, with no stepped rabbets and free from burrs, may be produced with a thickness of up to 400 mm. The maximum depth of the stationary mold half 1/1 is 200 mm.

The adjusting frame may be set freely over a distance of 50 mm.

Preferably the maximum depth of the two mold halves is at least 100 mm and in particular at least 200 mm. Preferably, the maximum depth of one mold half is greater than that of the other mold half, so that these mold halves may be used for the production of burr-free insulation boards without stepped rabbets. This deeper mold half is preferably the mold half which does not have the adjusting frame 6, since the deeper the mold half, the heavier it is. The corresponding weight must be borne by the adjusting frame and moved by the actuator 30.

Also provided is a central control unit, which automatically sets the adjusting frame 6 in the correct position, as well as the mold bases 3 relative to the mold frame 2. With such a tool it is therefore possible to produce a wide variety of insulation boards in any desired sequence, without the need for any manual adjustment for this purpose.

In the above embodiment, each of the two mold halves 1 has a depth setting device, with which the respective mold base 3 may be moved relative to the corresponding mold frame 2. In the context of the present invention it is also possible for only on or neither of the mold halves to be provided with a depth setting device. If the mold half has no depth setting device, then the mold frame and the mold base of the mold half concerned are preferably made in one piece. The mold base may then e.g. be welded all round with the mold frame.

In the context of the invention it is also possible for both mold halves 1 to be adjustable in a plane parallel to the mold bases 3, while the adjusting directions of the two mold halves are preferably orthogonal or perpendicular to one another.

### LIST OF REFERENCE NUMBERS

1 mold half

2 mold frame

3 mold base

4 press frame

5 frame part

6 adjusting, frame

7 frame element

8 longitudinal member

9 cross-member

10 intermediate member

11 support plate

12 reinforcing strut

14 filler connection

15 filler connection

16 longitudinal strut

17 lifting punch

18 drive motor

19 gear

20 projection

21 guide element

22 guide pin

23 diagonal direction

24 projection

25 securing hole

26 securing pin

27 edge

28 claw

29 slide plate

30 actuator

31 trough-shaped recess

32 boundary edge

33 load roller

34 locating pin

35 linear actuator

While this invention has been particularly shown and described with references to preferred embodiments thereof, it will be understood by those skilled in the art that various changes in form and details may be made therein without departing from the scope of the invention encompassed by the appended claims.

What is claimed is:

1. A tool for production of foamed insulation boards, wherein the insulation boards have two side faces lying opposite one another and all-round end faces, the tool comprising:
two mold halves, each having a mold frame and a mold base, so that the two mold halves together bound a mold cavity, which corresponds roughly to an insulation board to be produced, wherein the mold frames define the end faces of an insulation board to be produced, and the mold bases define the side faces of an insulation board to be produced,
a setting device for setting the position of the two mold halves in a plane parallel to the mold bases.

2. The tool according to claim 1, wherein the setting device is designed for stepless setting of the position of the two mold halves relative to one another.

3. The tool according to claim 1, wherein the mold frames have the shape of a rectangle and the setting device is designed for setting the position of the two mold halves in a direction inclined through 45° to the edge of the rectangle.

4. The tool according to claim 1, wherein each of the mold halves has a press frame which may be connected to a press, and arranged on one of the two press frames is an adjusting frame to which one of the mold frames and one of the mold bases are fixed, and the adjusting frame is mounted movably on the press frame, and an actuator is provided for stepless movement of the adjusting frame relative to the press frame.

5. The tool according to claim 4, wherein the actuator has an electrical, hydraulic or pneumatic drive unit.

6. The tool according to claim 4, wherein the press frame comprises claws for fixing the adjusting frame, the claws being operated hydraulically, pneumatically or electrically.

7. The tool according to claim 4, further comprising a slide bearing between the adjusting frame and the corresponding press frame.

8. The tool according to claim 7, wherein the slide bearing supports two contact faces of the adjusting frame and the press frame, which are arranged roughly parallel to the mold bases and have a slide plate and/or a ball bearing.

9. The tool according to claim 4, wherein the press frame comprises at least one load hearing which, with vertical arrangement, fits closely on a lower end face of the adjusting frame, wherein the adjusting frame has adjacent to the load bearing a trough-shaped recess open at the bottom, so that the load bearing in a zero position abuts an apex of the recess.

10. The tool according to claim 1, further comprising a depth setting device, by which the mold base of one of the mold halves are moved relative to the corresponding mold frame in a direction roughly perpendicular to the plane of the mold base.

11. The tool according to claim 1, wherein the mold bases have one or more steam feed inlets.

12. The tool according to claim 1, wherein at least one of the mold frames and/or at least one of the mold bases has a filler connection for the supply of foam particles.

13. The tool according to claim 1, further comprising at least one locating pin, which, by means of a linear actuator, is extended into the mold cavity and retracted from the mold cavity.

14. The tool according to claim 1, wherein the foamed insulation boards are facade insulation boards for the insulation of buildings.

15. An apparatus for production of foamed insulation boards, the apparatus comprising:
a tool comprising two mold halves and a setting device, each of the two mold halves having a mold frame and a mold base, so that the two mold halves together bound a mold cavity, which corresponds roughly to an insulation board to be produced, wherein the mold frames define the end faces of an insulation board to be produced, and the mold bases define the side faces of an insulation board to be produced, and wherein the setting device sets the position of the two mold halves in a plane parallel to the mold bases; and
a press, by which the two mold halves are pressed together.

16. The apparatus according to claim 15, further comprising a heating device for heating the mold cavity, wherein the heating device has a steam generator to produce steam and/or a generator for the generation of electromagnetic waves.

17. The apparatus according to claim 15, wherein the foamed insulation boards are facade insulation boards for the insulation of buildings.

18. A method for production of foamed insulation boards, wherein the insulation boards have two side faces lying opposite one another and all-round end faces, the method comprising:
providing a tool comprising two mold halves, each having a mold frame and a mold base, so that the two mold halves together bound a mold cavity, which corresponds roughly to an insulation board to be produced,
using the mold frames to define the end faces of an insulation board to be produced;
using the mold bases to define the side faces of an insulation board to be produced; and
setting the position of the two mold halves in a plane parallel to the mold bases by setting of the position of the two mold halves relative to one another.
